(19) United States
(12) Patent Application Publication
(10) Pub. No.: US 2026/0195588 A1
(43) Pub. Date: Jul. 9, 2026

(54) NEURAL NETWORK WITH CONDITIONAL SHARED PARAMETERS

(71) Applicant: TEXAS INSTRUMENTS INCORPORATED, DALLAS, TX (US)

(72) Inventors: Arthur REDFERN, DALLAS, TX (US); John ROBERTSON, AUSTIN, TX (US)

(21) Appl. No.: 19/438,336

(22) Filed: Dec. 31, 2025

Related U.S. Application Data
(60) Provisional application No. 63/743,265, filed on Jan. 9, 2025.

(51) Int. Cl. G06N 3/08; G06F 17/16

(52) U.S. Cl. CPC G06N 3/08; G06F 17/16

(57) ABSTRACT

A processor-implemented method includes receiving a set of shared weights and receiving first input data to a first layer of a neural network. The processor-implemented method also includes determining, based on the first input data, weights for the first layer as a first combination of the set of shared weights. The weights for the first layer can be applied to the first input data. The processor-implemented method also includes receiving second input data to a second layer of the neural network and determining, based on the second input data, weights for the second layer as a second combination of the set of shared weights. The weights for the second layer can be applied to the second input data.

### CROSS-REFERENCE TO RELATED APPLICATION

This application claims the benefit of and priority to U.S. provisional patent application No. 63/743,265, filed on Jan. 9, 2025, and entitled “Neural Network with Conditional Shared Parameters,” which is incorporated herein by reference in its entirety.

### TECHNICAL FIELD

This disclosure relates to machine learning models and, more specifically, to systems and methods to utilize conditional shared parameters in neural networks.

### BACKGROUND

Neural networks are directed acyclic graphs. Data flows on connections between network nodes, which perform various operations that may frequently be controlled by weights. The weights can be adjusted through training so the network can perform complex functions. The weights for a given layer can be stored in memory, such as in a matrix or other data structure. The memory resources for storing weights can be significant, which can be burdensome particularly in computing systems constrained by memory and other compute resources.

### SUMMARY

One example relates to a processor-implemented method. The processor-implemented method includes receiving a set of shared weights and receiving first input data to a first layer of a neural network. The processor-implemented method also includes determining, based on the first input data, weights for the first layer as a first combination of the set of shared weights. The weights for the first layer can be applied to the first input data. The processor-implemented method also includes receiving second input data to a second layer of the neural network and determining, based on the second input data, weights for the second layer as a second combination of the set of shared weights. The weights for the second layer can be applied to the second input data.

Another example relates to a neural network that includes a first layer and a second layer. The first layer includes a first router configured to determine first scaling factors for one or more shared weight matrices based on first input data for the first layer. The first layer also includes a first weight generator configured to determine a first weight matrix for the first layer based on the first scaling factors and the one or more shared weight matrices. The first layer also includes a first operation configured to apply the first weight matrix to the first input data. The second layer includes a second router configured to determine second scaling factors for the one or more shared weight matrices based on second input data for the second layer. The second layer also includes a second weight generator configured to determine a second weight matrix for the second layer based on the second scaling factors and the one or more shared weight matrices. The second layer also includes a second operation configured to apply the second weight matrix to the second input data.

Yet another example relates to a processor-implemented method. The processor-implemented method includes receiving input data to a layer of a neural network and receiving a plurality of weight matrices, in which the plurality of weight matrices includes a first weight matrix having a first dimension and a second weight matrix having a second dimension different from the first dimension. The processor-implemented method also includes determining, based on the input data to the layer, a set of scaling factors. The processor-implemented method also includes determining, based in part on a product of the first weight matrix, the second weight matrix, and a first scaling factor of the set of scaling factors, a third weight matrix for the layer of the neural network. The third weight matrix can be applied on the input data to the layer.

### BRIEF DESCRIPTION OF THE DRAWINGS

FIG. 1 is a block diagram of an example of a neural network that includes layers utilizing shared weights for conditional processing.

FIG. 2 is a block diagram of an example of a convolutional neural network that includes layers utilizing shared weights for conditional processing.

FIG. 3 is an example of a routing function that can be implemented in the neural network of FIGS. 1 and 2.

FIG. 4 is a block diagram illustrating an example of a convolutional neural network.

FIG. 5 is a block diagram illustrating an example of building blocks for the body of the neural network of FIG. 4.

FIG. 6 is a block diagram illustrating another example of building blocks of a convolutional neural network implementing shared weights.

FIG. 7 is a block diagram illustrating an example layer of a neural network that utilizes conditional low rank weight perturbations.

FIG. 8 is a block diagram illustrating an example of a neural network that uses shared weights for conditional low rank weight perturbations.

FIG. 9 is a block diagram of an embedded system implementing an example neural network.

FIG. 10 is a flow diagram illustrating an example of a method for processing a set of input data using a neural network that includes share weights and conditional processing.

### DETAILED DESCRIPTION

This disclosure relates to machine learning models, and, more specifically, to systems and methods of using conditional shared parameters for neural networks.

An artificial neural network (also referred to herein as a neural network or, simply, a network) can be used to model and reproduce nonlinear functions for a variety of applications. The network can include a plurality of processing nodes arranged in multiple layers, in which nodes of one layer are connected to nodes of one or more other layers. The network can also include weights, scaling factors, and other parameters, which are applied to connections between nodes and node inputs for computations at the respective nodes.

Sharing weights among multiple layers of a neural network, particularly across a deep neural network, may reduce the overall memory usage, but may impact the performance, flexibility, and/or efficiency of the network. For example, using the same weights across multiple layers can affect the ability of a convolutional neural network to extract unique and relevant features through the network. Additionally, or alternatively, using the same weights for multiple layers can lead to loss of spatial information and/or introduce bias in learning. These challenges may further increase when implementing the neural network in devices that are constrained in memory and/or compute resources.

According to some examples disclosed herein, a neural network having a plurality of network layers can perform operations based on shared conditional parameters. As an example, a first layer of the neural network receives first input data and determines input-dependent parameters for the first layer, based on the first input data, as a combination of one or more shared parameters (e.g., shared weights stored in memory). The first layer applies the input-dependent parameters to the first input data for performing an operation and providing first output data for the first layer. A second layer of the neural network receives second input data and determines input-dependent parameters for the second layer, based on the second input data, as a combination of the one or more shared parameters, which were also used by the first layer. The second input data may be based on the first output data directly or indirectly. The second layer applies the input-dependent parameters to the second input data for performing an operation and providing second output data for the second layer.

Advantageously, utilizing input-dependent parameters, such as an input-dependent combination of a set of weights, at multiple layers may enable increased network depth and improved network performance with little or no increase in memory usage compared with networks that use the same shared weights at multiple layers. Further, shared conditional convolution may improve the efficacy of the layers while also reducing memory and compute resources for the overall network compared to existing network architectures having static weights. For example, a neural network having shared conditional convolutions in multiple layers may achieve target performance using fewer parameters, making the model less resource-intensive, which is particularly beneficial for deployment on devices with limited resources. Still further, a neural network utilizing shared conditional convolutions may result in reduced parameter complexity, which can enable faster training and optimization.

In another example, one or more layers of a neural network (e.g., a convolutional neural network) include a weight generator and a respective operation for each of the one or more layers. The weight generator uses conditional low rank perturbations to generate weights applied to input data for performing the respective operation for each of the one or more layers. As an example, a layer of the neural network receives input data. Additionally, first and second weights (e.g., first and second weight matrices) are loaded from memory for the layer of the neural network. The weight generator determines third weights for the layer of the neural network as a combination (e.g., a product) of the first weights and the second weights and based on the input data of the layer, such as to provide a weight matrix for the layer. The third weights may have a higher dimension than the second weights and the first weights. The respective operation (e.g., convolution) includes applying the third weights (e.g., the determined weight matrix for the layer) on the input data of the layer to provide output data for the layer.

Advantageously, using low-rank perturbations can reduce the number of weights used for a layer of a neural network or other machine learning model. Additionally, the conditional low rank perturbations can achieve input-dependent weighting that is adaptive and more memory efficient than typical weighting used in static convolution operations. Further, sharing the low-rank perturbations among multiple layers may further reduce the overall weight size. Additionally, input-dependent (conditional) combination of the set of low-rank weights used (shared) by multiple layers can achieve benefit of deep neural network without increasing the weight size. Moreover, the reduced weights resultant from conditional low-rank perturbations may enable faster training and reduce computational overhead, making the network less resource-intensive and particularly suited for deployment in resource-constrained (e.g., memory constrained and/or compute-constrained) environments.

The layers, and methods described herein may be utilized as building blocks for constructing neural networks, including convolutional neural networks. Some example applications include vision (e.g., classification, object detection, image based semantic segmentation, depth and motion processing, etc.), audio (e.g., speech to text translation, etc.), as well as other operations (e.g., text generation, point cloud processing, etc.). As a result of including the conditional operations using shared parameters disclosed herein in the neural network, the neural network can be efficiently executed and exhibit improved accuracy compared to many existing networks in resource-constrained (e.g., memory constrained and/or compute-constrained) environments.

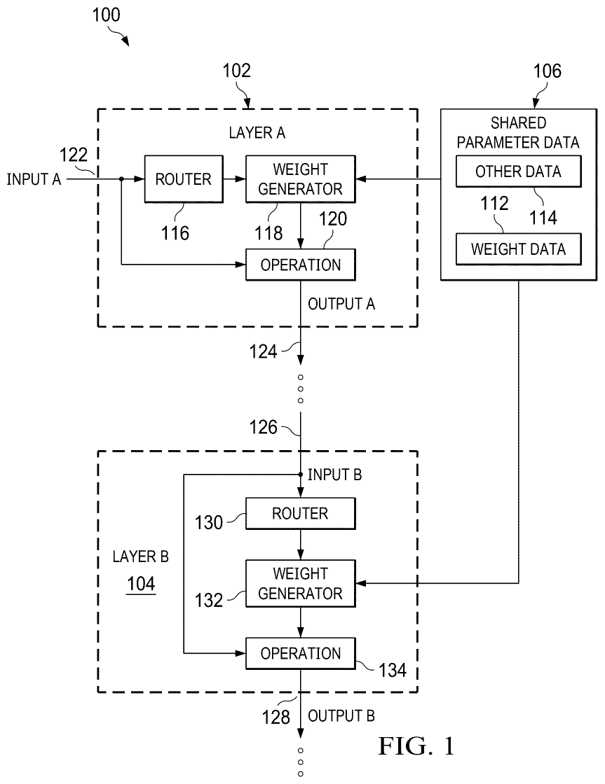

FIG. 1 is a block diagram of an example of a neural network 100 that may perform conditional operations. As described herein, the neural network 100 can be trained (e.g., using TensorFlow or PyTorch framework) for deployment within memory and computational constraints of embedded processing circuits or other resource-constrained environments. For example, the neural network 100 can be implemented as instructions and data (e.g., weights, scaling factors, and other network parameters) executable by one or more processors and/or accelerators in a system on chip (SOC) or system in package (SIP) that includes an embedded processing circuit.

In the example of FIG. 1, the neural network 100 includes one or more layers 102 and 104, shown as LAYER A and LAYER B, and shared parameter data 106. The neural network 100 may also include other layers not shown in FIG. 1. The shared parameter data 106 includes weight data 112 (also referred to as shared weight data) that may be used by two or more layers 102 and 104 of the neural network 100. For example, the weight data 112 includes one or more weight matrices that have been learned during training of the neural network 100 for applying (e.g., for performing operations, such as convolutions) at each of the two or more layers. In some examples, the shared parameter data 106 may include other data 114, such as one or more other parameters (e.g., biases, quantization scaling factors, etc.) that can be used by one or more layers for processing input data received at respective layers.

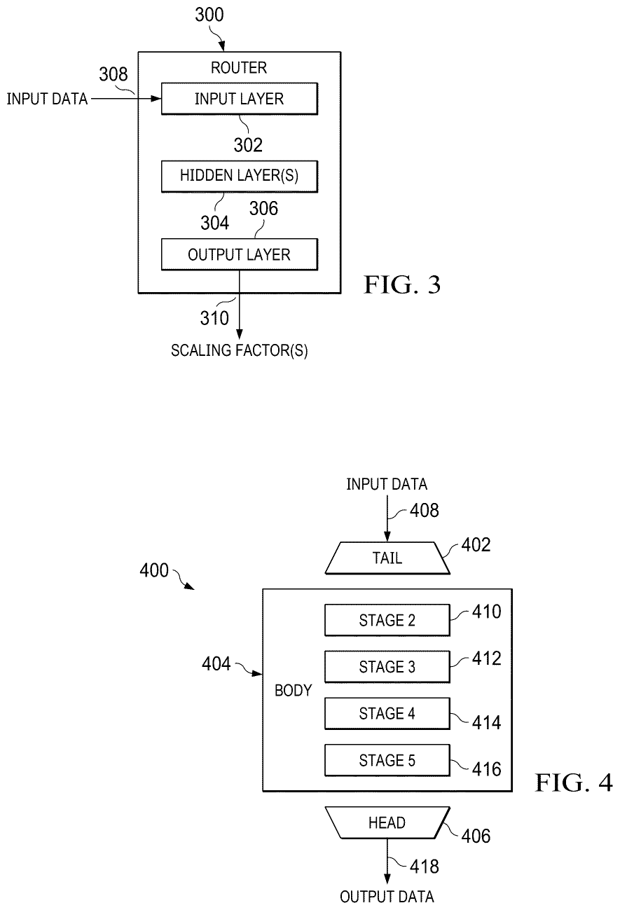

As an example, the layer 102 includes a router 116, a weight generator 118, and an operation 120. The layer 102 has an input 122 and an output 124. The input 122 receives input data for the layer 102, shown as INPUT A, and the output 124 provides output data for the layer, shown as OUTPUT A. The router 116 determines one or more scaling factors based on at least a portion of the input data INPUT A for the layer 102. For example, the router 116 may implement a machine learning model, such as a simple multilayer perceptron (MLP) or another model (see, e.g., FIG. 3) trained to determine one or more scaling factors based on the input data received at the input 122. The router 116 may determine each of the one or more scaling factors as a value (e.g., a scalar value) for adjusting each of the shared weight matrices in the weight data 112 based on the input data received at the input 122. The scaling factors thus operate as input-dependent weights for combining the shared weight matrices.

The weight generator 118 applies the scaling factors to the shared weights to provide a weight matrix having input-dependent weights for the layer 102. As disclosed herein, the weight data 112 may include one or more weight matrices. For example, the weight generator receives multiple weight matrices and adjusts each of the multiple weight matrices based on a respective one of the scaling factors (e.g., provided by router 116) to provide input-dependent weight matrices. The weight generator 118 further combines the input-dependent weight matrices (e.g., by summing the matrices) to provide a weight matrix for the layer 102 having input-dependent weights for the layer 102. The weight matrix having input-adjusted weights can be stored in memory (e.g., system memory or local memory such as cache of an embedded processing circuit).

The operation 120 applies the input-dependent weights to the input data INPUT A to provide the OUTPUT A for the layer 102. The operation 120 can implement one or more network processing functions, such as a convolution (e.g., a one- or multi-dimensional convolution, such as matrix multiplication) for the layer. The operation 120 or one or more subsequent layers may further implement one or more other functions, such as activation functions (e.g., hyperbolic tangent (tanh) function, the rectified linear unit (ReLU) function, etc.), a normalization function (e.g., batch normalization), a pooling function, or other functions based on the output OUTPUT A provided at the output 124.

The layer 104 (LAYER B) has an input 126 and an output 128. The input receives an input, shown as INPUT B, and the output 128 provides output data for the layer, shown as OUTPUT B. The input B may include or be based on the output provided by one or more preceding layers, including OUTPUT A provided by layer 102. Similar to the layer 102, the layer 104 processes the input data received at 126, shown as INPUT B, based on one or more shared parameters, including the shared weight data 112. The layer 104 includes a router 130, a weight generator 132, and an operation 134. The router 130 determines one or more scaling factors based on at least a portion of the input data INPUT B for the layer 104. For example, the router 130 is a machine learning model, such as an MLP or another model (see, e.g., FIG. 3) trained to determine one or more scaling factors based on the input data received at the input 126. The router 130 may determine each of the one or more scaling factor as a value (e.g., a scalar value) for adjusting each of the shared weight matrices in the weight data 112 based on the INPUT B received at the input 126.

The weight generator 132 applies the scaling factors to the shared weights (in the shared weight data 112) to provide one or more weight matrices having input-dependent weights for the layer 104. For example, the weight generator 132 receives multiple weight matrices and adjusts each of the multiple weight matrices based on a respective one of the scaling factors (e.g., provided by router 130) to provide multiple input-dependent weight matrices. The weight generator 132 further combines the input-dependent weight matrices (e.g., by summing the matrices) to provide a weight matrix for the layer 104 having input-dependent weights for the layer 104. The weight matrix having input-dependent weights can be stored in memory (e.g., system memory or local memory such as cache of an embedded processing circuit).

The operation 134 applies the input-dependent weights to the input data INPUT B to provide output data, shown as OUTPUT B, for the layer 104. The operation 134 can implement one or more network processing functions, such as a convolution (e.g., a one- or multi-dimensional convolution) for the layer 104. OUTPUT B may be provided to one or more convolution and/or other layers depending on the configuration of the neural network 100. An output layer (not shown in FIG. 1) of the neural network 100 may include, for example, a fully connected layer, which may be trained to classify an initial input data received by the neural network. Other functions can also be performed by the output layer of the neural network 100.

The shared parameter data 106, including weight data 112, may be shared by two or more layers, which may reside in one or more building blocks, of the neural network 100. As a result, additional network depth may be implemented in the neural network 100 with minimal or no added memory for storing weights of the neural network. Advantageously, the neural network 100 may be implemented with increased accuracy in embedded processor systems or other resource constrained environments compared to other network architectures.

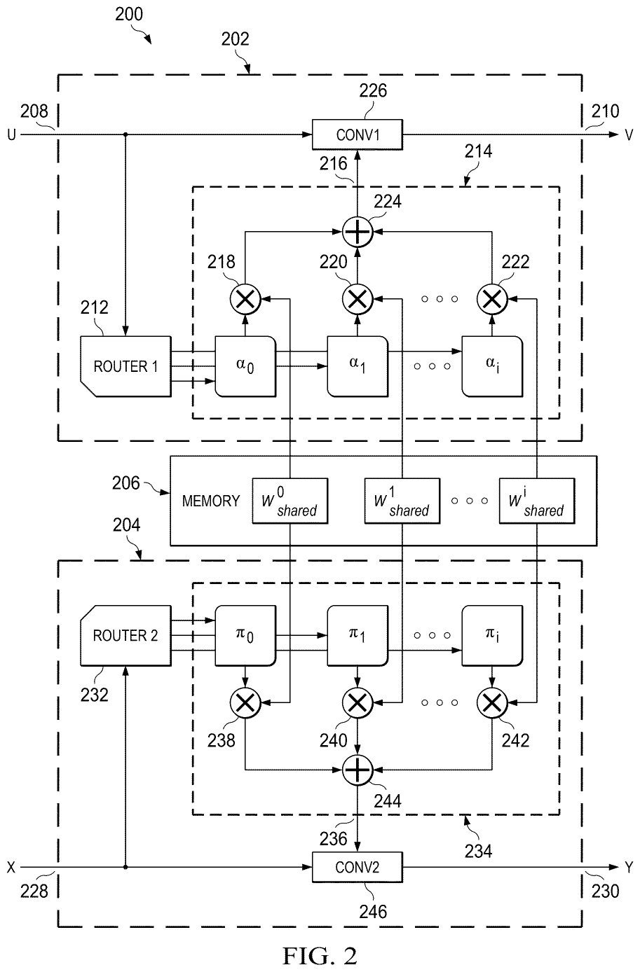

FIG. 2 is a block diagram of another example of a neural network 200 that includes layers utilizing shared weights for conditional convolutions. The neural network 200 includes a plurality of layers, including multiple layers 202 and 204 trained to perform convolution operations that utilize shared weights, shown as weight matrices

$${W}_{S H A R E D}^{0} , {W}_{S H A R E D}^{1} , … , {W}_{S H A R E D}^{i} ,$$

where i is a positive integer representing the number of shared weight matrices (i>0). The weight matrices

$${W}_{S H A R E D}^{0} , {W}_{S H A R E D}^{1} , … , and {W}_{S H A R E D}^{i}$$

may be loaded into memory 206 during execution of the neural network for use by at least layers 202 and 204. The neural network 200 is an example of the neural network 100 of FIG. 1. Accordingly, the description of FIG. 2 may refer to certain aspects of FIG. 1.

The layer 202 includes an input 208 and an output 210. In the example of FIG. 2, the input 208 receives input data, shown as U, which may be a feature map provided by the input or a preceding layer of the neural network 200 (not shown). For example, the preceding layer may be a fully connected layer or another convolutional layer that performs an operation on other input data to provide the input data U. The layer 202 includes a router (ROUTER 1) 212 and a weight generator 214. The router 212 has an input that receives the input data U for the first layer and determines, based on the input data U, scaling factors shown as α₀, α₁, . . . , and αᵢ. Each of the scaling factors shown as α₀, α₁, . . . , and αᵢ varies as a function of the input data U received at the input of the layer 202. The router 212 provides one of the scaling factors α₀, α₁, . . . , and αᵢ for each of the weight matrices

$${W}_{S H A R E D}^{0} , {W}_{S H A R E D}^{1} , … , {W}_{S H A R E D}^{i} .$$

The router 212 may be a function, such as a machine learning model (e.g., MLP or other models) trained with the neural network 200 to determine the scaling factors α₀, α₁, and αᵢ. For example, each of the scaling factors α₀, α₁, . . . , and αᵢ is a scalar value that defines a relative contribution (e.g., influence) of the weights in a respective one of the weight matrices

$${W}_{S H A R E D}^{0} , {W}_{S H A R E D}^{1} , … , and {W}_{S H A R E D}^{i} .$$

The weight generator 214 receives the scaling factors α₀, α₁, and αᵢ and the weight matrices

$${W}_{S H A R E D}^{0} , {W}_{S H A R E D}^{1} , … , and {W}_{S H A R E D}^{i} ,$$

and determines a weight matrix 216 for the layer 202 based on the scaling factors and the one or more shared weight matrices. For example, the weight generator includes multipliers 218, 220, . . . , and 222 that each multiply one of scaling factors α₀, α₁, and αᵢ with a respective one the weight matrices

$${W}_{SHARED}^{0} , {W}_{SHARED}^{1} , … , and {W}_{SHARED}^{i}$$

to provide scaled weight matrices

$${α}_{0} * {W}_{S H A R E D}^{0} , {α}_{1} * {W}_{S H A R E D}^{1} , … , and {α}_{i} * {W}_{S H A R E D}^{i} .$$

The weight generator 214 also includes an adder (or another function or operator) 224 to combine the scaled weight matrices

$$( e . g . , {α}_{0} * {W}_{SHARED}^{0} + {α}_{1} * {W}_{SHARED}^{1} + … + {α}_{i} * {W}_{SHARED}^{i} )$$

and provide the weight matrix 216 for the layer 202. Other functions are possible to determine the weight matrix 216 for the layer 202 as a combination of the shared weight matrices. The layer 202 also includes a convolution operation 226, shown as CONV1, that applies the weight matrix 216 on the input data U for performing convolutions on the input data U and providing an output V at the output 210 of the layer 202. The convolution may use a 1×1, 2×2, 3×3, or another convolution kernel that is applied to the input data U according to a stride to provide an output feature map defining the output V at the output 210. Because the weight matrix 216 that is applied by convolution operation 226 for performing the convolutions depends on shared matrices

$${W}_{S H A R E D}^{0} , {W}_{S H A R E D}^{1} , … and {W}_{S H A R E D}^{i}$$

and the input U, the convolution CONV1 that is performed likewise may be referred to as a shared weight conditional convolution (or simply shared conditional convolution).

The layer 204 includes an input 228, which receives input data X, and an output 230. The input data X may be a feature map provided by a preceding layer, such as the layer 202 or another intervening layer of the neural network 200 (not shown). For example, X may include or be derived from output V from the layer 202. The layer 204 includes a router (ROUTER 2) 232 and a weight generator 234. The router 232 has an input that receives the input data X for the layer 204 and determines, based on the input data X, scaling factors shown as π₀, π₁, . . . , and πᵢ. Each of the scaling factors π₀, π₁, and πᵢ varies as a function of the input data X received at the input 228 of the layer 204. The router 232 may provide one of the scaling factors π₀, π₁, . . . and πᵢ (e.g., scalar values) for each of the weight matrices

$${W}_{S H A R E D}^{0} , {W}_{S H A R E D}^{1} , … and {W}_{S H A R E D}^{i} .$$

Other numbers of scaling factors are possible in other examples. The router 232 may be a function, such as a machine learning model (e.g., MLP or another model) trained with the neural network 200 to determine the scaling factors π₀, π₁, . . . and πᵢ. In some examples, the routers 212 and 232 for the layers 202 and 204 that share the weight matrices may be a shared router (e.g., instances of the same router code) or may be based on a same model but have different parameters.

The weight generator 234 receives the scaling factors π₀, π₁, . . . , and πᵢ and one or more of the weight matrices

$${W}_{S H A R E D}^{0} , {W}_{S H A R E D}^{1} , … , and {W}_{S H A R E D}^{i}$$

and determines a weight matrix 236 for the layer 204 based on the scaling factors and the one or more shared weight matrices. For example, the weight generator includes multipliers 238, 240, and 242 (also referred to as respective multiplication operations) each configured to multiply one of scaling factors π₀, π₁, . . . , and πᵢ with a respective one of the weight matrices

$${W}_{S H A R E D}^{0} , {W}_{S H A R E D}^{1} , … , and {W}_{S H A R E D}^{i}$$

to provide scaled weight matrices

$${π}_{0} * {W}_{S H A R E D}^{0} , {π}_{1} * {W}_{S H A R E D}^{1} , … , and {π}_{i} * {W}_{S H A R E D}^{i} .$$

The weight generator 234 also includes an adder (e.g., an addition operation or other function) 244 to combine the scaled weight matrices

$$( {π}_{0} * {W}_{S H A R E D}^{0} + {π}_{1} * {W}_{S H A R E D}^{1} + … + {π}_{i} * {W}_{S H A R E D}^{i} )$$

and provide the weight matrix 236 for the layer 204. Other functions are possible to determine the weight matrix 236 for the layer 204 as a combination of the shared weight matrices. The layer 204 also includes a convolution operation 246, shown as CONV2, that applies the weight matrix 236 for performing convolutions on the input data X and providing an output Y at the output 230 of the layer 204. The convolution (e.g., a shared conditional convolution) may include a convolution kernel that convolves over the input data X according to a stride to provide an output feature map defining the output Y at the output 230.

The neural network 200 may include one or more other layers, including an output layer (not shown in FIG. 2) that provides output results. The results generated by the output layer of the neural network 200 can be, for example, a classification label or a numeric value, which can depend on the particular task that the neural network 200 is trained to perform.

FIG. 3 is an example of a routing function 300 (also referred to herein as a router) that can be used in the neural networks of FIGS. 1 and 2. In one example, the routing function is an MLP. Other types and configurations of routing functions are possible. In the example illustrated in FIG. 3, the routing function 300 includes an input layer 302, one or more intermediate (e.g., hidden) layers 304, and an output layer 306. The input layer 302 has an input 308 to receive input data, such as a feature map or other forms of data. For example, the input layer 302 is a pooling layer that implements a pooling function (e.g., average pooling or maximum pooling) and provides a set of values as inputs to each of the nodes of the first of one or more intermediate layers 304. As an example, the one or more intermediate layers 304 may be one or more fully connected layers having nodes, in which the nodes include functions that apply respective weights (e.g., a weight vector) to the data provided from the input layer 302 to provide respective values. Each of the fully connected layers 304 may be followed by an activation function (e.g., a rectified linear unit (ReLU) function) and/or another function (e.g., batch normalization) to provide respective output values as inputs to a next layer, which may be another intermediate layer 304 or the output layer 306. The output layer 306 can be implemented as a SoftMax or another function that provides a set of i outputs (where i represents the number of outputs) at an output 310 of the routing function 300. The set of i outputs provided at the output 310 may define a respective scaling factor to be applied (e.g., by weight generator 118, 132, 214, 234) to shared parameters (e.g., shared weight data 112, or weight matrices stored in memory 206) for providing scaled weight values, as described herein. Other types of routing functions are possible for providing input-dependent scaling factors.

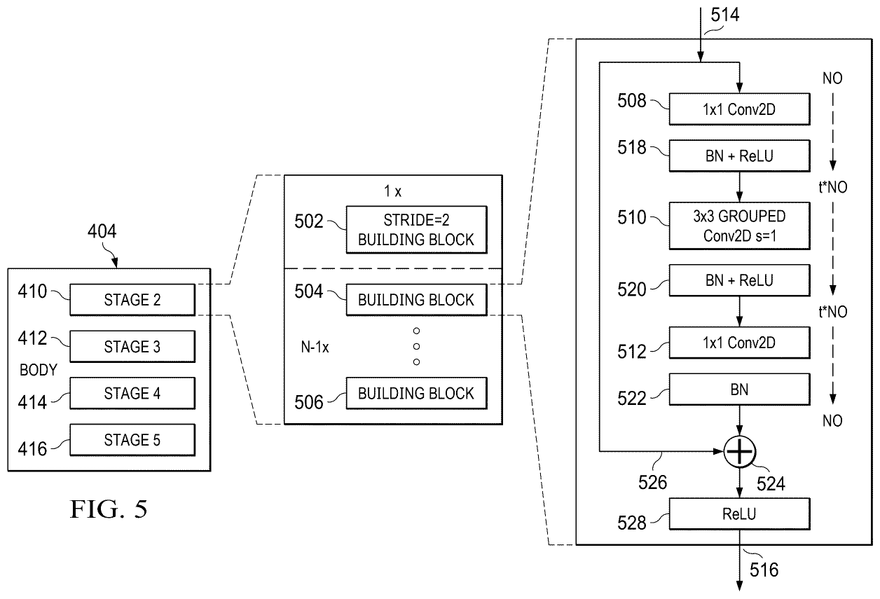

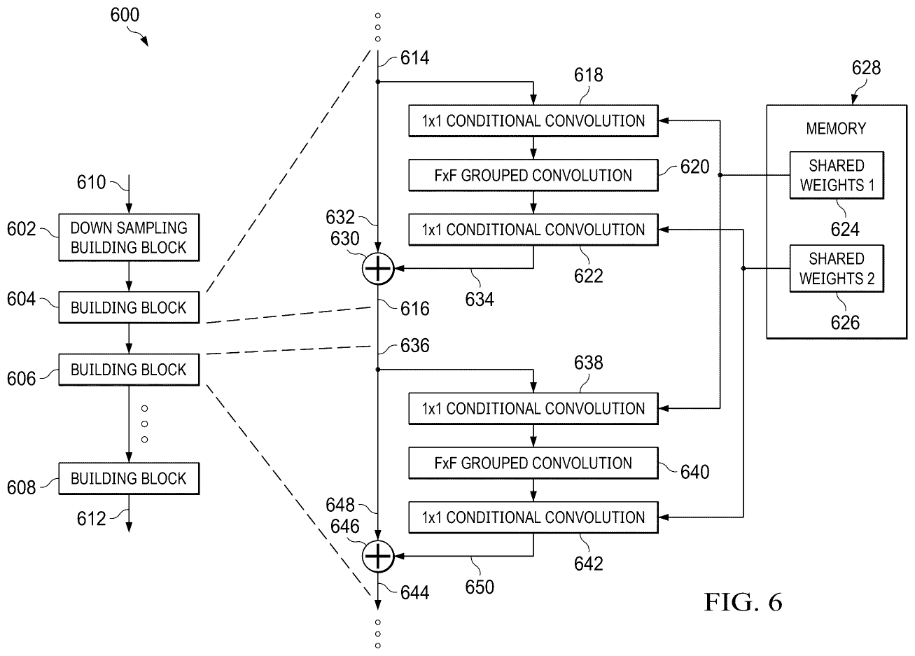

FIGS. 4, 5, and 6 depict an example of a convolutional neural network (also referred to as a neural network) 400 that includes a tail 402, a body 404, and a head 406. The tail 402 defines an entry point for the neural network 400 and has an input 408 that receives input data. The body 404 includes a plurality of stages 410, 412, 414, and 416, shown as stage 2, stage 3, stage 4, and stage 5. As shown in FIG. 5, each of the stages 410, 412, 414, and 416 may include building blocks 502, 504, and 506 each having one or more layers that may share weights (e.g., weight matrices) with other layers, such as for implementing shared conditional convolutions. Layers of the building blocks 502, 504, and 506, which may include convolution operations (e.g., including shared conditional convolutions), may be trained to implement convolutions and/or other functions for extracting features and improving the strength and accuracy of the extracted features as data propagates through the body 404 from tail 402 to head 406. The head 406 has an output 418 and generates an output for the neural network 400. The output can depend on the particular task that the neural network 400 is designed to perform, such as to indicate a prediction, probability, and/or confidence for the task, and have a form (e.g., value or set of values) consistent with that task.

In the example shown in FIG. 5, the building block 502 is shown as a convolution block having a stride 2, such as for downsampling input data received from tail 402. FIG. 5 further demonstrates an example of building block 504 that includes a plurality of layers 508, 510, and 512 and other functions coupled between an input 514 and an output 516 of the building block 504. Input data received at the input 514 to the building block 504 has a number of channels, shown as No. For example, the building block 504 includes a residual path, which includes a 1×1 convolutional layer 508, a 3×3 convolutional layer 510 (e.g., labelled as a 3×3 grouped Conv2D and having a stride=1), and a 1×1 convolutional layer 512. The 1×1 convolutional layer 508 reduces the dimensionality of the input data from No to a reduced number of channels, shown as t*No (e.g., t is a parameter that is less than 1) and the 3×3 convolutional layer 510 performs main spatial convolutions. The 1×1 convolutional layer 512 increases the dimensionality back to the desired level No. Additional functions can be implemented in the residual path following (or part of) each of the layers 508, 5110, and 512 to improve performance of the building blocks. For example, batch normalization (BN) and ReLU functions 518 and 520 follow layers 508 and 510, respectively. A batch normalization function 522 can follow convolutional layer 512 to normalize the outputs provided by such layer. An adder 524 (also referred to as an addition operation) combines the output of batch normalization function 522 with the input data received via an identity path 526 to provide an aggregate output that is provided to another ReLU function 528 for adding nonlinearity to the aggregate output. Other numbers and configurations of layers and functions are possible for implementing building blocks in the convolutional neural networks or other types of neural networks.

FIG. 6 depicts part of another example of a stage 600 of a neural network (e.g., neural network 400) implementing shared conditional convolutions. Stage 600 includes a plurality of building blocks 602, 604, 606, . . . , and 608 between an input 610 and an output 612. As shown in FIG. 6, more detailed views of building blocks 604 and 606 are included to illustrate some examples of layers that may be implemented in the respective building blocks. Other types and configurations of layers are possible for these or other building blocks.

As shown in FIG. 6, the building block 604 has an input 614 and an output 616. The input 614 may be connected to the preceding building block 602 to receive data (as input data) from an output of building block 602. The output 616 is connected to the next building block 606 to provide output data to an input of building block 606. The building block 604 includes a plurality of layers 618, 620, and 622 between the input 614 and the output 616 to form a residue path. In the example of FIG. 6, the layer 618 is configured to perform a 1×1 conditional convolution operation based on a first set of shared weights 624 (e.g., a first set of shared weight matrices). For example, the layer 618 uses a router and weight generator (e.g., router 116 or 212 and weight generator 118 or 214) to adjust the first set of shared weights 624, such that the conditional convolution operation performed by the layer is an input-dependent operation. The layer 620 is configured to perform an F×F grouped convolution operation, where F represents the kernel size for a grouped convolution filter. The grouped convolution operation of the layer 620 may be performed based on a set of weights trained specifically for the layer 620, such as to group input channels and implement independent feature learning (e.g., for image recognition or other classification operations). Various dimensions are possible for the kernel size performed by the layer 620. The layer 622 is configured to perform another 1×1 conditional (e.g., input-dependent) convolution operation based on a second set of shared weights 626 (e.g., a second set of shared weight matrices). For example, the layer 622 uses a router and weight generator (e.g., router 130 or 232 and weight generator 132 or 234) to adjust the second set of shared weights 626, such that the conditional convolution operation performed by the layer depends on the input to the layer 622.

In the example of FIG. 6, the first and second sets of shared weights 624 and 626 may be stored in memory 628 (e.g., system memory or local memory such as cache) and represent different shared weights determined for the neural network. In other examples, the first and second sets of shared weights 624 and 626 may represent the same shared weights. An adder 630 combines the input data received at the input 614 via an identity path 632 (from building block 602) and output data provided by the residue path to an output 634 of the layer 622 to provide output data at the output 616 of the building block 604.

The output data provided at the output 616 may be input data that is received at an input 636 of the next building block 606. The building block 606 includes a first layer 638 and additional layers 640 and 642 that are connected with the first layer 638 between the input 636 and the output 644 to form a residue path. In the example of FIG. 6, the layer 638 is configured to perform a 1×1 conditional convolution operation based on the first set of shared weights 624. The layer 640 is configured to perform an F×F grouped convolution operation. The layer 642 is configured to perform another 1×1 conditional convolution operation based on the second set of shared weights 626. An adder 646 combines the input data received at the input 636 (e.g., the output from building block 604) via an identity path 648 with output data provided by the residue path to an output 650 of the layer 642 to provide output data at the output 644 of the building block 606. In the example of FIG. 6, the layers 618 and 638 each use the first set of shared weights 624, and the layers 622 and 642 each use the second set of shared weights 626 to perform respective conditional convolution operations (e.g., input-dependent convolution operations), such as described herein. The first and second sets of shared weights 624 and 626 and/or other shared weights may be used by one or more layers of one or more other building blocks of one or more stages of the neural network. Advantageously, by implementing shared weights for conditional (e.g., input-dependent) convolution, memory requirements may be reduced and/or the loading time may be decreased for the neural network 600.

As another example, conditional low-rank weight perturbations may be utilized to generate input-dependent weights (e.g., weight matrices) in neural networks, including convolutional neural networks. Using low-rank perturbations can reduce the weights used for each layer. For example, a full-rank weight matrix of 1000×1000 weights can be approximated as a combination of lower dimension weight matrices of 1000×R and R×1000 (where R represents the size of lower column or row dimensions, e.g., R=1, 2, or another positive integer). In this example, the full-rank matrix has 1 million weights compared to two thousand weights (for R=1) or four thousand weights (for R=2) for the lower dimension matrices. An even more significant reduction in weights can be realized when using multiple pairs of lower dimension weight matrices that are combined in a data dependent manner to generate weights for one or more layers of the network, compared with using multiple matrices with higher dimensions for conditional convolution. The use of such conditional low-rank perturbations, as described herein, can be adaptive and more parameter efficient than weighting used in static convolution operations or conditional convolution operations using full-rank or higher dimension weight matrices.

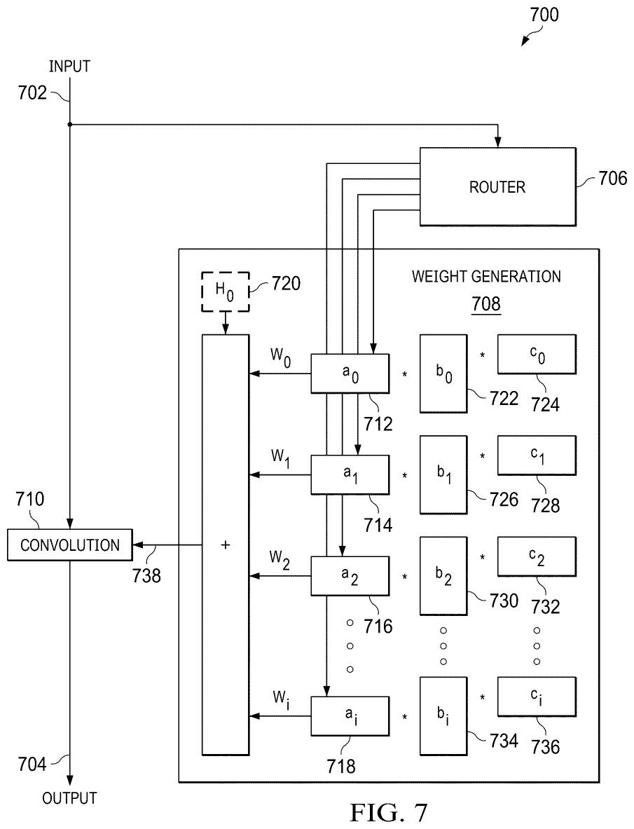

FIG. 7 is a block diagram illustrating an example layer 700 of a neural network that uses conditional low rank weight perturbations. The layer 700 has an input 702 and an output 704, in which the input 702 receives input data (e.g., from another layer of the neural network—not shown) and the layer 700 provides output data at the output 704. The layer 700 includes a router 706, a weight generator 708, and a convolution operation 710. The router 706 has an input that receives the input data for the layer 700 and determines, based on the input data, a set of scaling factors 712, 714, 716, . . . , and 718, shown as a₀, a₁, a₂, . . . , and aᵢ, where i is a positive integer representing the number of scaling factors. As described above with respect to, for example, FIG. 3. the router 706 may be implemented as a machine learning model that is trained jointly with the layer 700 and the neural network or as another type of function configured to determine the scaling factors 712, 714, 716, . . . , and 718. Each of the scaling factors 712, 714, 716, and 718 varies as a function of the input data received at the input 702 of the layer 700 and has a value (e.g., a scalar value) for performing input-dependent weighting (e.g., by weight generator 708).

The weight generator 708 receives the scaling factors 712, 714, 716, and 718 and a plurality of weight matrices 720, 722, 724, 726, 728, 730, 732, 734, and 736, shown as H₀, b₀, c₀, b₁, c₁, b₂, c₂, bᵢ, and cᵢ. In some examples, one or more of the weight matrices (up to and including all of the weight matrices) 720, 722, 724, 726, 728, 730, 732, 734, and 736 may be shared by one or more other layers of the neural network. In some examples, one or more of the weight matrices 720, 722, 724, 726, 728, 730, 732, 734, and 736 may be determined specifically for the layer 700, such as during training of the neural network. Additionally, or alternatively, the layer 700 may include one or more other functions, such as activation functions (e.g., a hyperbolic tangent (tanh) function, a rectified linear unit (ReLU) function, etc.), a normalization function (e.g., batch normalization), a pooling function, and the like.

The weight generator 708 has an output 738 and is configured to generate an input-dependent weight matrix for the layer 700 at the output 738 as a combination of the scaling factors 712, 714, 716, and 718 and the weight matrices 720, 722, 724, 726, 728, 730, 732, 734, and 736. For example, each of the weight matrices 722, 726, 730, and 734 may have a rank that is different from the rank of its associated weight matrix 724, 728, 732, or 736, which may be lower than the rank of the weight matrix 720. As an example, the weight matrix 720 (e.g., an initial weight matrix for the layer 700) is a full rank matrix and each pair of the weight matrices 722-724, 726-728, 730-732, and 734-736 may be lower rank decompositions of the weight matrix 720. Because each pair of the weight matrices 722-724, 726-728, 730-732, and 734-736 has a different rank than the weight matrix 720, the weight matrices 720, 722, 724, 726, 728, 730, 734, and 736 may be referred to as low-rank weight matrices, and each pair of the weight matrices 722-724, 726-728, 730-732, and 734-736 (e.g., b₀-c₀, b₁-c₁, b₂-c₂, and bᵢ-cᵢ) defines a respective low-rank matrix pair. In some examples, weight matrices 722, 726, 730, . . . , and 734 may have the same rank, while weight matrices 724, 728, 732, . . . , and 736 may have the same rank. In some examples, weight matrices 722, 726, 730, . . . , and 734 may have different ranks from each other, and weight matrices 724, 728, 732, . . . , and 736 may also have different ranks from each other.

As a further example, the weight generator 708 is configured to combine each pair of the weight matrices 722-724, 726-728, 730-732, . . . , and 734-736, such as through a matrix multiplication or through other mathematical or combinatorial operations. For example, the weight matrix 720 is an M×N matrix (where M and N are positive integers representing the numbers of rows and columns, respectively, of the weight matrix), and each of the matrices 722, 726, 730, and 734 is an M×R matrix (where R represents the number of columns), and each of the matrices 724, 728, 732, and 736 is an R×N matrix. As a result, the product of each pair of the weight matrices 722-724, 726-728, 730-732, and 734-736 (e.g., b₀*c₀, b₁*c₁*b₂*c₂, and bᵢ*cᵢ) is an M×N matrix having the same dimensions as the weight matrix 720, which may have a higher dimension than each of the other weight matrices 722, 724, 726, 728, 730, 732, 734, and 736. The weight generator 708 further applies the scaling factors 712, 714, 716, and 718 to the products of the weight matrices to provide a set of scaled weight matrices, shown as W₀, W₁, W₂, and Wᵢ, which are generated through low-rank perturbations and in an input dependent manner (based on the input data to the layer 700). For example, W₀=a₀*b₀*c₀, Wᵢ=a₁*b₁*c₁, W₂=a₂*b₂*c₂, and Wᵢ=a₀*b₀*c₀ The weight generator 708 is further configured to combine the scaled weight matrices W₀, W₁, W₂, and Wᵢ with the weight matrix 720 to provide a resultant weight matrix for the layer 700 at the output 738 of the weight generator 708. The convolution operation 710 may be performed on the input data 702 based on the weight matrix provided at the output 738, and may provide the output data for the layer 700 based on the convolution operation performed with the weight matrix. Advantageously, by implementing input-dependent mapping using low-rank matrices for the layer 700, the layer may be implemented with reduced memory and increased parameter efficiency than many existing structures.

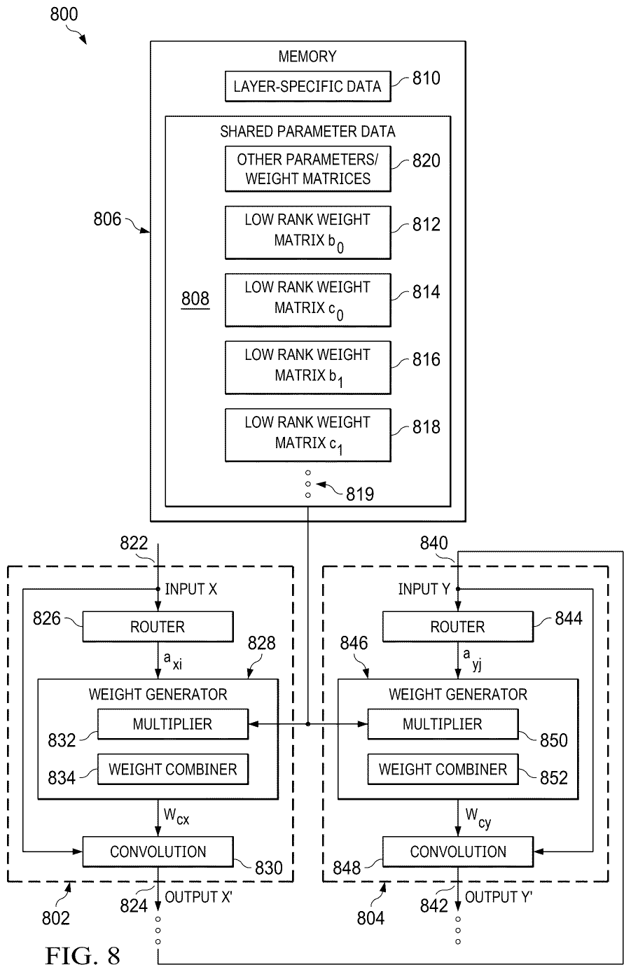

FIG. 8 is a block diagram illustrating an example of a neural network 800 that includes a plurality of layers 802 and 804. Parameters for the plurality of layers 802 and 804 can be stored in memory 806 and received from memory during execution of the neural network for performing inference operations (e.g., image classification, object detection, speech recognition, etc.). Each of the layers may be implemented as an instance of the layer 700 of FIG. 7 or in other configurations. In the example of FIG. 8, the memory 806 includes shared parameter data 808, which includes parameters (e.g., one or more sets of weight matrices) that are shared by two or more layers of the neural network 800. Additionally, or alternatively, the memory 806 may also store layer-specific data 810 for one or more layers of the neural network 800. The layer-specific data 810 can include parameters, such as weights, biases, quantization scales, etc., and/or executable instructions trained to implement one or more respective layers of the neural network 800. For example, the layer-specific data 810 for a layer may include parameters of the routing function for the layer and/or any layer-specific weights.

As an example, the shared parameter data 808 includes a plurality of weight matrices, including a first low rank weight matrix 812 (shown as b₀), a second low rank weight matrix 814 (shown as c₀), a third low rank weight matrix 816 (shown as b₁), a fourth low rank weight matrix 818 (shown as c₁), and so on. The first low rank weight matrix 812 has a dimension that is different from the second low rank weight matrix 814, and the third low rank weight matrix 816 has a dimension that is different from the fourth low rank weight matrix 818. In some examples, weight matrices 812 and 816 may have different dimensions (and/or ranks) and weight matrices 814 and 818 may have different dimensions (and/or ranks). In some examples, weight matrices 812 and 816 may have the same dimensions and weight matrices 814 and 818 may have the same dimensions. In this context, the full rank weight matrix refers to the rank of a kernel (or filter) to be applied in a convolution operation for multiple layers (e.g., including layers 802 and 804) of the neural network. As a further example, the first and second low rank weight matrices 812 and 814 have dimensions M×R and R×N, respectively, and are a first matrix pair, which may represent rank decompositions of a full rank weight matrix (having dimensions M×N), and the third and fourth low rank weight matrices 816 and 818 are a second matrix pair also having dimensions M×R′ and R′×N, which may represent low rank decompositions of the full rank weight matrix. R may be the same as or different from R′. More than two pairs of low rank weight matrices are possible, in other examples, as indicated by ellipsis 819 shown in FIG. 8. The shared parameter data 808 may also include other parameters and/or weight matrices 820 that are shared by two or more layers of the neural network. For example, the other parameters and/or weight matrices 820 may optionally include a full rank weight matrix that has been trained for shared use in more than one layer of the neural network 800.

As described herein, the kernel (or filter) to be applied in the convolution operations for two or more layers of the neural network 800 may be derived in part from the first, second, third, and fourth low rank weight matrices 812, 814, 816, and 818. For example, the layer 802 has an input 822 and an output 824, in which the input 822 receives input data, shown as INPUT X, which may be provided by another layer of the neural network 800 (e.g., a pooling layer or another convolutional layer). The layer 802 also provides output data, shown as OUTPUT X′, at the output 824. INPUT X may include an input feature map and OUTPUT X′ may include an output feature map. The layer 802 includes a router 826, a weight generator 828, and a convolution operation 830 as described above with respect to, for example, FIG. 7. The router 826 determines a set of scaling factors (aₓᵢ), each having, for example, a scalar value that is determined as a function of INPUT X, where: x indicates that the scaling factors are for the layer 802 that receives INPUT X, and i represents the number of scaling factors. As described above, the router 826 may be implemented as a machine learning model (see, e.g., routing function 300) that is trained jointly with the neural network 800. Other functions or operations to implement the router 826 are possible.

The weight generator 828 receives the set of scaling factors and is configured to generate an input-dependent weight matrix W_{cx} based on the set of scaling factors aₓᵢ and at least some of the shared parameter data 808. Additionally, or alternatively, the weight generator 828 can generate the input-dependent weight matrix W_{cx} based on the layer-specific data 810. In the example of FIG. 8, the weight generator 828 includes a multiplier 832 (e.g., a matrix multiplier) and a weight combiner 834. The multiplier 832 combines pairs of low rank weight matrices (e.g., by performing multiplication function) to provide computed weight matrices, for example, products of each pair of low rank weight matrices. For example, the weight generator 828 may apply the set of scaling factors aₓᵢ, as an input-dependent weighting, to each of the computed weight matrices. For example, the multiplier 832 multiplies the product of first and second low rank weight matrices 812 and 814 and a first of the scaling factors (aₓ₀) to provide a first computed weight matrix W₀ₓ having a desired dimension (e.g., W₀ₓ=aₓ₀*b₀*c₀) for the convolution operation 830. The multiplier 832 also multiplies the product of third and fourth low rank weight matrices 816 and 818 and a second of the scaling factors (aₓ₁) to provide a second computed weight matrix W₁ₓ having the same desired dimension (e.g., W₁ₓ=aₓ₁*b₁*c₁). More than two computed weight matrices may be determined by the multiplier 832. The weight combiner 834 is configured to combine the computed weight matrices W₀ₓ and W₁ₓ determined by the multiplier 832 to provide a convolution weight matrix W_{cx} for performing the convolution operation 830. In one example, the weight combiner 834 adds the computed weight matrices to provide the convolution weight matrix (e.g., W_{cx}=W₀ₓ+W₁ₓ). In another example, the weight combiner 834 adds the computed weight matrices and a full rank weight matrix Wₓ to provide the convolution weight matrix (e.g., W_{cx}=Wₓ+W₀ₓ+W₁ₓ). The full rank weight matrix Wₓ may be stored in the memory 806 as part of the shared parameter data 808, which is used by one or more other layers of the neural network, or as part of the layer-specific data 810. In either case, the full rank weight matrix Wₓ is trained with the neural network to represent a set of weights for influencing the convolution operation 830. In some examples, the full rank weight matrix Wₓ may be scaled using a scale factor generated by router 826, and then combined with computed weight matrices W₀ₓ and W₁ₓ. In some examples, the set of scaling factors may be applied by the weight combiner 834 rather than the multiplier 832. The convolution operation 830 may be performed by applying the convolution weight matrix W_{cx} on INPUT X to provide OUTPUT X′ for the layer 802. In some examples, additional operations (e.g., normalization, activation, pooling, etc.) may be performed on OUTPUT X before supplying an adjusted version of OUTPUT X′ to a next layer of the neural network 800.

The layer 804 may be implemented in the neural network 800 as part of the same or different building block and/or in the same or different stage from the layer 802. In the example of FIG. 8, the layer 804 shares at least the same low rank weight matrices 812, 814, 816, and 818 with the layer 802 for determining an input-dependent weight matrix W_{cy} for the layer 804. The layer 804 has an input 840 and an output 842, in which the input 840 receives input data, shown as INPUT Y. The layer 804 also provides output data, shown as OUTPUT Y′, at the output 842. INPUT Y may include an input feature map and OUTPUT Y′ may include an output feature map. As shown in FIG. 8, INPUT Y is dependent on OUTPUT X′ provided by the layer 802 directly or indirectly. For example, INPUT Y may be provided directly by the layer 802 (e.g., OUTPUT X′=INPUT Y). Alternatively, INPUT Y may be provided by another layer of the neural network 800, such as one or more layers between the layers 802 and 804.

The layer 804 is configured similarly to layer 802 but, being later in the neural network 800, may be trained to identify different or more complex patterns than the layer 802. The layer 804 includes a router 844, a weight generator 846, and a convolution operation 848. The router 844 determines, based on INPUT Y, a set of scaling factors (a_{yj}) for the layer 804, in which each scaling factor has a scalar value, y indicates that the scaling factors are for the layer 804 that receives INPUT Y, and j represents the number of scaling factors used in the layer 804. The weight generator 846 receives the set of scaling factors and is configured to generate an input-dependent weight matrix W_{cy} based on the set of scaling factors and at least some of the shared parameter data 808. Additionally, or alternatively, the weight generator 846 can generate the input-dependent weight matrix W_{cy} based on the layer-specific data 810.

In the example of FIG. 8, the weight generator 846 includes a multiplier 850 (e.g., a matrix multiplier) and a weight combiner 852. The multiplier 850 combines multiple pairs of low rank weight matrices to provide computed weight matrices, for example, products of each pair of low rank weight matrices. The weight generator 846 may apply the set of scaling factors a_{yj}, as an input-dependent weighting, to manipulate each of the computed weight matrices. For example, the multiplier 850 multiplies first and second low rank weight matrices 812 and 814 and a first of the scaling factors (a_{y0}), which is determined (e.g., by router 844) for the layer 804, to provide a first computed weight matrix W_{0y} having a desired dimension for the convolution operation 848 (e.g., W_{0y}=a_{y0}*b₀*c₀). The multiplier 850 also multiplies third and fourth low rank weight matrices 816 and 818 and a second of the scaling factors (a_{y1}) to provide another computed weight matrix W_{1y} having the same desired dimension (e.g., W_{1y}=a_{y1}*b₁*c₁). More than two computed weight matrices may be determined by the multiplier 850. The weight combiner 852 is configured to combine the computed weight matrices W_{0y} and W_{1y} determined by the multiplier 850 to provide a convolution weight matrix W_{cy} for the convolution operation 848. In one example, the weight combiner 852 adds the computed weight matrices to provide the convolution weight matrix (e.g., W_{cy}=W_{0y}+W_{1y}). In another example, the weight combiner 834 adds the computed weight matrices and a full rank weight matrix W_{y} to provide the convolution weight matrix for the layer 804 (e.g., W_{cy}=W_{y}+W_{0y}+W_{1y}). The full rank weight matrix W_{y} may be stored in the memory 806 as part of the shared parameter data 808 (e.g., part of other parameters/weight matrices 820), which is used by one or more other layers of the neural network (e.g., W_{y}=Wₓ). Alternatively, the full rank weight matrix W_{y} may be stored in the memory 806 as part of the layer-specific data 810, and may be different from Wₓ. In either case, the full rank weight matrix W_{y} is trained with the neural network to represent a set of weights for influencing the convolution operation 848. In some examples, the weight combiner may apply the set of scaling factors generated by router 844 to the full rank weight matrix W_{y} and products of the pairs of low rank weight matrices (e.g., b₀*c₀, b₁*c₁, etc.) to generate the convolution weight matrix for the layer 804. There can be any number of additional layers following layer 804 according to application requirements.

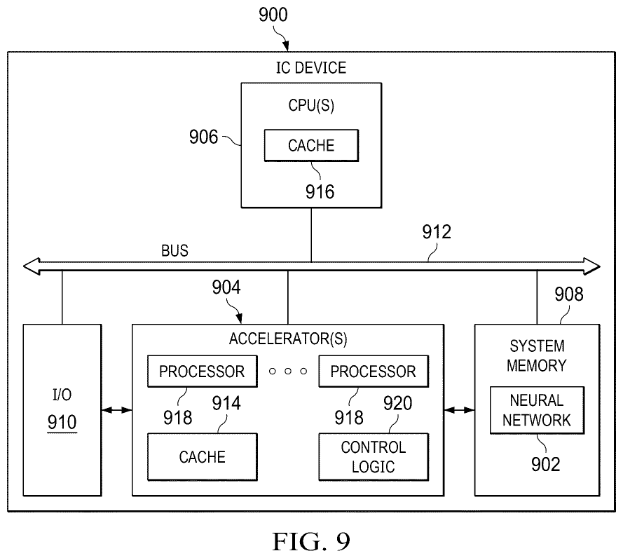

FIG. 9 is a block diagram of an example of an integrated circuit (IC) device 900 (e.g., a semiconductor device) that may execute a neural network 902 that is trained to implement shared conditional convolution and/or conditional low rank perturbations. The neural network 902 may include two or more layers implemented according to any of the examples disclosed herein (e.g., neural networks 100, 200, 400, 600, and 800 or layer 700). For example, the IC device 900 can be an SOC device including embedded processor(s), such as an ARM processor based on the reduced instruction set computing (RISC) architecture or a RISC-V processor. In the example of FIG. 9, the IC device 900 includes one or more accelerators 904, one or more central processing units (CPUs) 906, system memory 908, and an input/output (I/O) system 910, each of which can be coupled to an internal bus 912 (e.g., an interconnect) of the IC device 900.

The system memory 906 (e.g., one or more storage media, such as Static Random Access Memory (SRAM), Dynamic Random Access Memory (DRAM), and/or various forms of Read-Only Memory (ROM)) can include data and instructions configured to implement the neural network 902 that, when executed by the CPU(s) 906 and/or accelerator(s) 904, cause the CPU(s) and/or accelerator(s) to perform functions described herein.

As an example, the neural network 902 (e.g., implemented by CPU(s) 906 and/or accelerator(s) 904) can receive a set of input data. In an example, the set of input data includes an image or frames of video, an audio file, or another type of data to be processed by the neural network 902. The set of input data can be provided to the CPU through the I/O system 910 and stored in the system memory 908 for processing according to the trained neural network. In some examples, the set of input data (or a portion thereof) can be stored in cache 914 of the accelerator(s) 904 and/or in cache 916 of the CPU(s) 906. In an example, the caches 914 and 916 define a shared cache memory structure (e.g., L2 or L3 cache) that allows both the accelerator(s) 904 and the CPU(s) 906 to access the same data (e.g., including one or more sets of shared weight matrices) without copying the data to facilitate implementing the neural network 902. The accelerator(s) 904 can be coupled to the system memory 908 through the internal bus 912. Additionally, or alternatively, the accelerator(s) 904 can be coupled to the system memory 906 directly to enable direct memory access of data and/or instructions in the system memory, such as the neural network 902 and/or data that is propagated through and/or computed by respective layers of the neural network.

In the example of FIG. 9, the accelerator(s) 904 can also include one or more processors 918, the cache 914, and control logic 920. The one or more processors 918 of the accelerator(s) 904 can be implemented as, for example, digital signal processors (DSPs), graphic processing units (GPUs), tensor processing units (TPUs), network processing units (NPUs), and additional hardware to accelerate computations such as for machine learning, image processing, and signal processing. In an example, the one or more processors 918 (e.g., DSPs) includes hardware configured to perform matrix multiply-accumulate (MMA) operations that include matrix multiplication followed by an accumulation operation. The MMA can compute the product of two matrices, including shared low rank matrices, and add the result to an accumulator, such as for performing operations in layers of the neural network, as disclosed herein. As described above, the accelerator(s) 904 and/or the CPU(s) 906 may also perform other operations of the neural network, such as data/weight quantization/dequantization, activation, and pooling. The control logic 920 is configured to control the flow of data and instructions between the accelerator(s) 904 and the CPU(s) 906 for executing operations for the neural network 902 based on the set of input data.

As a further example, the neural network 902 can include a plurality of layers (e.g., layers 102, 104, 202, 204, 508, 510, 512, 618, 620, 622, 638, 640, 642, 700, 802, and 804) trained to perform respective operations, such as disclosed herein. At least some layers of the neural network 902 each include a router (e.g., router 116, 130, 212, 232, 300, 706, 826, 844), a weight generator (e.g., weight generator 118, 132, 214, 234, 708, 828, 846), and an operation (e.g., operation 120, 134, 226, 246, 710, 830, 848). The router of a respective layer determines a set of scaling factors for one or more shared weight matrices based on input data received at each respective layer. The weight generator determines an input-dependent set of weights, such as a weight matrix, for the respective layer based on the set of scaling factors and a set of weights received at the respective layer. As disclosed herein, the weight generator may determine the input-dependent set of weights based on a set of shared weights (e.g., the one or more shared weight matrices) and the scaling factors determined for the respective layer. Additionally, or alternatively, the set of weights received at the respective layer may include multiple low rank weight matrices, and the weight generator may determine the input-dependent set of weights as a combination of the low rank weight matrices and the scaling factors. The CPU(s) 906 and/or accelerator(s) 904 can execute instructions that cause the CPU(s) and/or accelerator(s) to perform the operation by applying the input-dependent set of weights to the input data. The operation may provide resultant output data for the respective layer. The CPU(s) 906 and/or accelerator(s) 904 can execute further instructions that cause the CPU(s) and/or accelerator(s) to perform convolutions and/or other operations on data as the data propagates through respective layers of the neural network 902.

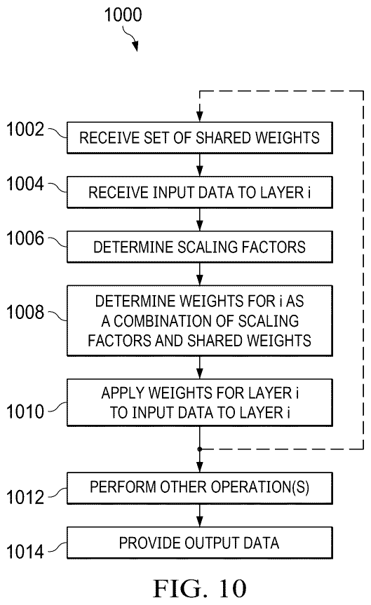

FIG. 10 is a flow diagram depicting an example method 1000 for processing a set of input data using a neural network. The method 1000 can be executed by one or more processors (e.g., digital signal processors, accelerators, CPUs, and/or other types of processors) of an IC, an SOC, and SIP, or another computing device based on a set of instructions (e.g., software and/or firmware) that have been compiled for the processor(s) and stored in memory. While, for purposes of simplicity of explanation, the example method 1000 is shown and described as executing serially, it is to be understood and appreciated that the example method is not limited by the illustrated order. The method 1000 can be implemented by executing the neural network 100, neural network 200, neural network 400, and/or neural network 902.

At 1002, the method 1000 includes receiving a set of shared weights. For example, the set of shared weights are stored in memory (e.g., system or local memory) and retrieved from memory for performing operations of the neural network. The values for the set of shared weights (e.g., one or more weight matrices) are determined for multiple layers of the neural network during training of the neural network. One instance of the set of shared weights may be stored in the memory for use by the multiple layers.

At 1004, input data is received at a given layer (shown as layer i) of the neural network. The input data may include or be derived (e.g., by one or more preceding layers of the neural network) from an image, frames of video, an audio file, or another type of data to be processed by the neural network. For example, the input data received at layer i is an input feature map that is provided by a preceding layer and/or another intermediate function (e.g., a down sampling or ReLU function).

At 1006, scaling factors are determined for layer i based on the received input data (at 1004). For example, a router (e.g., router 116, 130, 212, 232, 300, 706, 826, 844) is configured to determine a set of scaling factors, as a function of input data (received at 1004). The set of scaling factors may include a scalar value for each respective weight in the set of the shared weights received at 1002. At 1008, the method 1000 includes determining weights for layer i as a combination of the scaling factors and the shared weights. For example, a weight generator (e.g., weight generator 118, 132, 214, 234, 708, 828, 846) combines the shared weights (received at 1002) and the scaling factors (determined at 1006), such as by multiplying each scaling factor in the set of scaling factors with a respective shared weight matrix (or respective shared matrices) and combining the products to provide the weights (e.g., a weight matrix, such as an input-dependent weight matrix) for layer i. At 1010, the weights for layer i are applied to the input data. For example, at 1010, layer i includes an operation (e.g., operation 120, 134, 226, 246, 710, 830, 848), such as a convolution operation, that is performed on the input data for layer i (received at 1004).

Other operations are possible for one or more intervening layers between successive layers that implement shared conditional convolutions based on a set of shared weights. For example, at 1012, one or more other operations may be performed by the network performing the method 1000. For example, the one or more other operations may include convolution or other inferencing operations, such as activation, normalization, pooling, etc. At 1014, the method includes providing output data for the neural network. For example, an output layer of the neural network may provide a classification label or a numeric value, which can depend on the particular task that the neural network (e.g., network 100, 200, 400, or 902) is designed to perform.

As indicated by dashed line returning from 1010 (or from 1014) to 1002, the method may be repeated for each of the layers that use the shared weights. Depending on whether there are sufficient resources, the shared weights may be uploaded separately for each layer or may remain loaded in memory for more than one layer. When multiple layers share the shared weights (received at 1002), the devices and systems implementing the neural network can achieve improved memory efficiency and/or realize increased accuracy, particularly for deep networks, compared to many existing architectures.

It should be understood that various aspects described herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this description are described as being performed by a single module or unit for purposes of clarity, it should be understood that the techniques of this description may be performed by a combination of units or modules.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a processor). For example, instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure(s) or any other physical structure suitable for implementation of the described techniques. Also, the techniques could be fully implemented in one or more circuits or logic elements.

In this description, numerical designations “first,” “second,” etc. are not necessarily consistent with same designations in the claims herein and these numerical designations are used to simply distinguish one element from another. Also, the term “based on” means based at least in part on.

Additionally, the term “couple” or variants thereof may cover connections, communications, or signal paths that enable a functional relationship consistent with this description. For example, if device A generates a signal to control device B to perform an action, then: (a) in a first example, device A is directly coupled to device B; or (b) in a second example, device A is indirectly coupled to device B through intervening component C if intervening component C does not alter the functional relationship between device A and device B, so device B is controlled by device A via the control signal generated by device A.

In this description, the term “based on” means based at least in part on. Also, as used herein, the term “includes” means includes but not limited to, and the term “including” means including but not limited to.

Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within +/−10 percent of that parameter. Modifications are possible in the described embodiments and other embodiments are possible within the scope of the claims.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Where the description or claims recite “a,” “an,” “a first,” or “another” element, or the equivalent thereof, it should be interpreted to include one or more than one such element, neither requiring nor excluding two or more such elements.

Furthermore, a circuit or device that is said to include certain components may instead be configured to couple to those components to form the described circuitry, device, or system. For example, a structure described as including one or more elements A, B and C may instead include only the A elements within a single physical device and may be configured to couple to at least some of the elements B and/or C to form the described circuitry, device, or system, either at a time of manufacture or after a time of manufacture, for example, by an end-user and/or a third-party.

All references, publications, and patents cited in the present application are herein incorporated by reference in their entirety.

What is claimed is:

1. A processor-implemented method comprising:
receiving a set of shared weights;
receiving first input data to a first layer of a neural network;
determining, based on the first input data, weights for the first layer as a first combination of the set of shared weights;
applying the weights for the first layer to the first input data;
receiving second input data to a second layer of the neural network;
determining, based on the second input data, weights for the second layer as a second combination of the set of shared weights; and
applying the weights for the second layer to the second input data.

2. The processor-implemented method of claim 1, wherein the set of shared weights comprise multiple shared weight matrices stored in memory.

3. The processor-implemented method of claim 2, wherein determining the weights for the first layer comprises:
determining scaling factors for the first layer based on the first input data; and
combining the multiple shared weight matrices using the scaling factors.

4. The processor-implemented method of claim 3, wherein combining the multiple shared weight matrices using the scaling factors comprises:
applying each of the scaling factors to a respective shared weight matrix of the multiple shared weight matrices to provide scaled weight matrices; and
combining the scaled weight matrices to generate the weights for the first layer.

5. The processor-implemented method of claim 3, wherein the scaling factors for the first layer are determined by a machine learning model, and wherein the machine learning model and the shared weight matrices are jointly trained with the neural network.

6. The processor-implemented method of claim 3, wherein the weights for the first layer form a first layer weight matrix having a first dimension, and the multiple shared weight matrices includes a first weight matrix and a second weight matrix that have lower dimensions than the first dimension.

7. The processor-implemented method of claim 6, wherein determining the weights for the first layer comprises:
multiplying the first weight matrix, the second weight matrix, and a first scaling factor of the scaling factors to generate a first computed weight matrix.

8. The processor-implemented method of claim 7, further comprising:
receiving a third weight matrix having the first dimension,
wherein determining the weights for the first layer further comprises summing the first computed weight matrix with the third weight matrix to generate the first layer weight matrix.

9. The processor-implemented method of claim 7, wherein determining the weights for the first layer further comprises:
multiplying a third weight matrix of the shared weight matrices, a fourth weight matrix of the shared weight matrices, and a second scaling factor of the scaling factors to generate a second computed weight matrix having the first dimension, wherein at least one of the third weight matrix or the fourth weight matrix has a dimension lower than the first dimension; and
summing the first computed weight matrix with the second computed weight matrix to generate the first layer weight matrix.

10. The processor-implemented method of claim 2, wherein the first layer and the second layer are part of a same stage of the neural network or part of different stages of the neural network.

11. The processor-implemented method of claim 1, wherein:
applying the weights for the first layer comprises performing a first convolution operation on the first input data based on the weights for the first layer; and
applying the weights for the second layer comprises performing a second convolution operation on the second input data based on the weights for the second layer.

12. A neural network, comprising:
a first layer, comprising:
a first router configured to determine first scaling factors for one or more shared weight matrices based on first input data for the first layer;
a first weight generator configured to determine a first weight matrix for the first layer based on the first scaling factors and the one or more shared weight matrices; and
a first operation configured to apply the first weight matrix to the first input data; and
a second layer, comprising:
a second router configured to determine second scaling factors for the one or more shared weight matrices based on second input data for the second layer;
a second weight generator configured to determine a second weight matrix for the second layer based on the second scaling factors and the one or more shared weight matrices; and
a second operation configured to apply the second weight matrix to the second input data.

13. The neural network of claim 12, wherein:
the one or more shared weight matrices comprise multiple shared weight matrices; and
the first weight generator is configured to:
apply each of the first scaling factors to a respective shared weight matrix of the shared weight matrices to provide scaled weight matrices; and
combine the scaled weight matrices to generate the first weight matrix.

14. The neural network of claim 12, wherein:
the first weight matrix has a first dimension; and
the shared weight matrices include at least two shared weight matrices having lower dimensions than the first dimension.

15. The neural network of claim 14, wherein the first weight generator comprises:
a first multiplier configured to multiply first and second weight matrices of the at least two shared weight matrices and a first scaling factor of the first scaling factors to provide a first computed weight matrix having the first dimension;
a second multiplier configured to multiply third and fourth weight matrices of the at least two shared weight matrices and a second scaling factor of the first scaling factors to provide a second computed weight matrix having the first dimension; and
an addition operation configured to add the first computed weight matrix with the second computed weight matrix to generate the first weight matrix.

16. The neural network of claim 14, wherein the first weight generator comprises:
a multiplier configured to multiply first and second weight matrices of the at least two shared weight matrices and a scaling factor of the first scaling factors to provide a computed weight matrix having the first dimension; and
an adder configured to add a third weight matrix of the first dimension with the computed weight matrix to generate the first weight matrix.

17. The neural network of claim 12, wherein the first router comprises a machine learning model.

18. The neural network of claim 12, wherein:
the first operation comprises a first convolution operation on the first input data, using the first weight matrix, and to generate a first output feature map; and
the second operation comprises a second convolution operation on the second input data,
using the second weight matrix, and to generate a second output feature map.

19. The neural network of claim 12, further comprising at least one of:
a normalization layer between the first layer and the second layer;
an activation layer between the first layer and the second layer; or
a pooling layer between the first layer and the second layer.

20. A processor-implemented method, comprising:
receiving input data to a layer of a neural network;
receiving a plurality of weight matrices, the plurality of weight matrices including a first weight matrix having a first dimension and a second weight matrix having a second dimension different from the first dimension;
determining, based on the input data to the layer, a set of scaling factors;
determining, based at least in part on a product of the first weight matrix, the second weight matrix, and a first scaling factor of the set of scaling factors, a third weight matrix for the layer of the neural network, the third weight matrix having a third dimension that is higher than the first dimension and the second dimension; and
applying the third weight matrix on the input data to the layer.

21. The processor-implemented method of claim 20, wherein:
the plurality of weight matrices further includes a fourth weight matrix having a fourth dimension and a fifth weight matrix having a fifth dimension different from the third dimension; and:
the processor-implemented method further comprises determining the third weight matrix based in part on a product of the fourth weight matrix, the fifth weight matrix, and a second scaling factor of the set of scaling factors.

22. The processor-implemented method of claim 21, wherein:
the product of the first weight matrix, the second weight matrix, and the first scaling factor is a sixth weight matrix;
the product of the fourth weight matrix, the fifth weight matrix, and the second scaling factor is a seventh weight matrix; and
the third weight matrix is determined based on a sum of the sixth weight matrix with the seventh weight matrix.

23. The processor-implemented method of claim 20, wherein the layer of the neural network is a first layer, the set of scaling factors is a first set of scaling factors, and the processor-implemented method further comprises:
receiving input data to a second layer of the neural network;
determining, based on the input data to the second layer, a second set of scaling factors;
determining, based at least in part on a product of the first weight matrix, the second weight matrix, and a first scaling factor of the second set of scaling factors, a fourth weight matrix for the second layer of the neural network, the fourth weight matrix having the third dimension; and
applying the fourth weight matrix on the input data to the second layer.

24. The processor-implemented method of claim 23, wherein the first set of scaling factors is determined by a first router and the second set of scaling factors is determined by a second router, wherein the first and second routers are configured to perform the same or different functions.
